(19) United States
(12) Patent Application Publication
(10) Pub. No.: US 2017/0164290 A1
(43) Pub. Date: Jun. 8, 2017

(54) REDUCED POWER CONSUMPTION FOR BROWSING WEBSITES

(71) Applicant: QUALCOMM Incorporated, San Diego, CA (US)

(72) Inventors: Veluppillai Arulesan, Toronto (CA); Shiu Wai Hui, Richmond Hill (CA); Stewart Chao, Markham (CA)

(21) Appl. No.: 14/962,827

(22) Filed: Dec. 8, 2015

(51) Int. Cl. H04W 52/02; H04L 29/08

(52) U.S. Cl. CPC H04W 52/0251; H04L 67/02

(57) ABSTRACT

An example method of conserving power within a browser application includes receiving, at a browser application, a webpage for rendering on a mobile device. The method also includes performing an action that conserves power within the browser application if the webpage is identified in a mobile database located on the mobile device. The mobile database stores identifiers of one or more websites that have been identified as high power consuming websites.

### FIELD OF DISCLOSURE

The present disclosure generally relates to computing devices, and more particularly to reducing the power consumption for rendering websites.

### BACKGROUND

Mobile devices are ubiquitous and may include a smartphone, tablet computer, portable digital assistant (PDA), portable game console, palmtop computer, and other portable electronic devices. In addition to the primary function of these devices, many include peripheral functions. Applications may be installed on the mobile device to provide these peripheral functions. In an example, an application is provided by a third party, and a user downloads the application onto the mobile device. In another example, the user receives the mobile device with the application already installed on the mobile device. One of the most common use cases after telephony on modern mobile devices is Web browsing. A mobile device may include the primary function of making telephone calls and the peripheral functions of Web browsing, which may be data heavy and time-consuming. As websites become more dynamic and heavy, the processing power required by the device to support such Web browsing functionality also increases.

Battery life is a key metric for mobile device users. In low-battery situations, conventional techniques may provide the user with information on which applications or games on the device are power hungry by using heuristics and information provided by the operating system. The power consumption rate for a browser hosted on a mobile device may vary depending on the website being requested by the user of the mobile device. For example, websites contain different content, and some websites may be heavy in content and data processing while others are not. Regardless, a browser is typically viewed as a power hungry application. Thus, if a user's smartphone is running low on battery power and the user attempts to browse the Internet, the user may do so but at the expense of running out of battery and having the smartphone shut off.

### BRIEF SUMMARY

Methods, systems, and techniques for conserving battery power within a browser application are provided.

According to an embodiment, a method of conserving power within a browser application includes receiving, at a browser application, a webpage for rendering on a mobile device. The method also includes performing an action that conserves power within the browser application if the webpage is identified in a mobile database located on the mobile device. The mobile database stores identifiers of one or more websites that have been identified as high power consuming websites.

According to another embodiment, a system for conserving power within a browser application includes a rendering engine that receives a webpage for rendering on a mobile device. The system also includes a power conservation module that performs an action that conserves power within the browser application if the webpage is identified in a mobile database located on the mobile device. The mobile database stores identifiers of one or more websites that have been identified as high power consuming websites. The rendering engine renders the webpage after the power conservation module performs the action if the power conservation module performs the action.

According to another embodiment, a computer-readable medium has stored thereon computer-executable instructions for performing operations including: receiving, at a browser application, a webpage for rendering on a mobile device; and performing an action that conserves power within the browser application if the webpage is identified in a mobile database located on the mobile device, the mobile database storing identifiers of one or more websites that have been identified as high power consuming websites.

According to another embodiment, an apparatus for conserving power within a browser application includes means for receiving, at a browser application, a webpage for rendering on a mobile device; and means for performing an action that conserves power within the browser application if the webpage is identified in a mobile database located on the mobile device, the mobile database storing identifiers of one or more websites that have been identified as high power consuming websites.

### BRIEF DESCRIPTION OF THE DRAWINGS

The accompanying drawings, which form a part of the specification, illustrate embodiments of the disclosure and together with the description, further serve to explain the principles of the embodiments. In the drawings, like reference numbers may indicate identical or functionally similar elements. The drawing in which an element first appears is generally indicated by the left-most digit in the corresponding reference number.

FIG. 1 is a block diagram illustrating a mobile device that may be used to implement the power conservation techniques of the present disclosure in accordance with one or more embodiments.

FIG. 2 is a simplified flowchart illustrating a method of conserving power within the browser application in accordance with one or more embodiments.

FIG. 3 is a simplified flowchart illustrating another method of conserving power within the browser application in accordance with one or more embodiments.

FIG. 4 is a block diagram of a computer system suitable for implementing one or more embodiments of the present disclosure.

### DETAILED DESCRIPTION

I. Overview
II. Example System Architecture
III. Example Methods
IV. Example Actions that Conserve Power within the Browser Application
V. Example Computing System

### I. Overview

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

One of the key metrics mobile device users care about is battery life. More and more users are using their mobile devices for Web browsing. Web browsing consumes battery power, and the amount of power consumed varies depending on the particular websites being accessed and the content of the websites. A user may desire to load websites, but with certain modifications to improve power conservation at the cost of the websites' performance. For example, if the user's mobile device is running low on battery power, the mobile device may display a warning to the user. The warning may inform the user that loading the requested webpage may be a fairly big drain on the battery. The browser application may request approval from the user to allow the browser application to modify the webpage or the operations performed for rendering the webpage to conserve power at the cost of performance.

The amount of power consumed by a browser application for rendering content of a webpage may be higher than is necessary to provide the user with the content that she actually desires to view. It may be desirable to reduce the power consumption of websites by gracefully degrading the performance of the websites. The user may opt to tradeoff the performance of a website for power improvement. For example, the webpage may include high power consuming elements that the user does not care to view (e.g., advertisements). To conserve power, the browser application may remove one or more of these high power consuming elements before rendering the webpage. Thus, the browser application may consume less power in rendering the webpage.

An embodiment of the disclosure may warn users of high power consumption websites to make users aware of such websites as well as provide them with a technique to choose lower website performance over higher power consumption. If a user is warned that her mobile device is in a low or constrained battery situation, the user may still desire to load the website but with certain modifications to improve power conservation at the cost of website performance. Accordingly, if the user attempts to load a website that has been previously tagged as “power hungry,” the browser application may present the user with various options to gracefully degrade the user's experience by knocking down the website's performance, but with the significant advantage of reducing the power consumption of the website.

The present disclosure provides techniques to conserve power within a browser application. For example, a user of a mobile device may be presented with options for graceful degradation of functionality and/or performance to save power when attempting to load power hungry webpages (e.g., in a mid to low battery situation). In some embodiments, an example method of conserving power within a browser application includes receiving, at a browser application, a webpage for rendering to a display coupled to a mobile device. The method also includes determining whether the webpage is identified in a mobile database located on the mobile device. The mobile database stores identifiers of one or more websites that have been identified as high power consuming websites. The method further includes in response to a determination that the webpage is identified in the mobile database, performing an action that conserves power within the browser application.

Unless specifically stated otherwise, as apparent from the following discussion, it is appreciated that throughout the description, discussions utilizing terms such as “receiving”, “sending”, “storing”, “identifying”, “determining”, and “providing”, “searching,” “performing,” “requesting,” “rendering,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### II. Example System Architecture

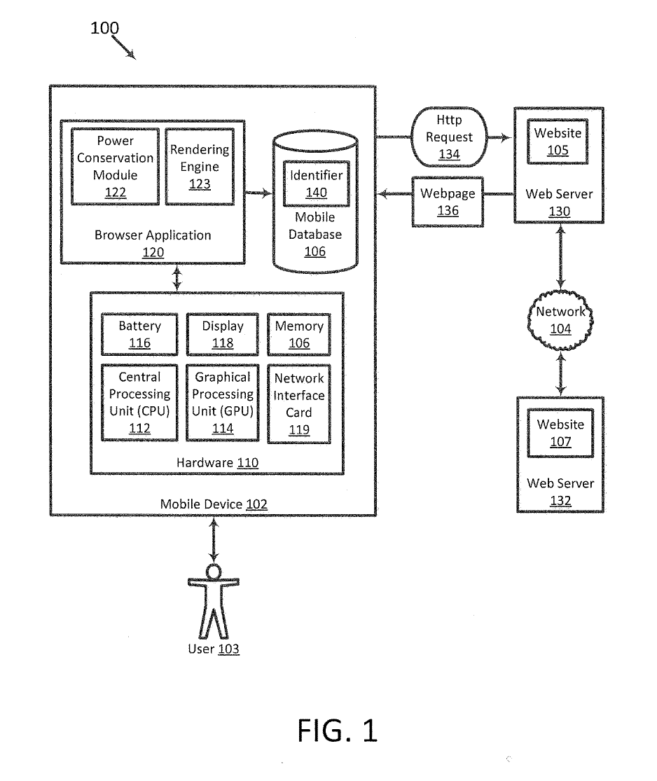

FIG. 1 is a block diagram 100 illustrating a mobile device 102 that may be used to implement the power conservation techniques of the present disclosure in accordance with one or more embodiments. Mobile device 102 is coupled to a network 104. Network 104 may include various configurations and use various protocols including the Internet, World Wide Web, intranets, virtual private networks, wide area networks, local networks, private networks using communication protocols proprietary to one or more companies, cellular and other wireless networks, Internet relay chat channels (IRC), instant messaging, simple mail transfer protocols (SMTP), Ethernet, Wi-Fi and Hypertext Transfer Protocol (HTTP), and various combinations of the foregoing.

Mobile device 102 may be, for example, a laptop computer, a wireless communication device (e.g., a mobile telephone, a cellular telephone, a satellite telephone, and/or a mobile telephone handset), a handheld device such as a portable video game device or a personal digital assistant (PDA), a personal music player, a video player, or any other type of mobile device that is capable of accessing data from a network.

Mobile device 102 includes hardware 110, which includes one or more central processing units (CPUs) 112, one or more graphics processing units (GPUs) 114, a battery 116, a display 118, and network interface card 119. Hardware 110 may also include other devices. A “CPU” may also be referred to as a “hardware processor,” “physical processor,” or “processor” herein. A CPU shall refer to a device capable of executing instructions encoding arithmetic, logical, or input/output (I/O) operations. In one illustrative example, a CPU may follow the Von Neumann architectural model and may include an arithmetic logic unit (ALU), a control unit, and a plurality of registers. CPU 112 may include a general-purpose or a special-purpose processor that controls operation of mobile device 102.

A user 103 may provide input to mobile device 102 via one or more input devices (not shown) such as a keyboard, a mouse, a microphone, a touch pad or another input device that is coupled to mobile device 102 via a user interface. The user may provide input to mobile device 102 to cause CPU 112 to execute one or more software applications. The software applications that execute on CPU 112 may include, for example, an operating system, a software application (e.g., a browser application 120, a word processor application, an email application, a spread sheet application, a video game application, a graphical user interface (GUI) application, or another program).

In a further aspect, a CPU may be a single core CPU that is typically capable of executing one instruction at a time (or process a single pipeline of instructions), or a multi-core CPU that may simultaneously execute multiple instructions. In another aspect, a CPU may be implemented as a single integrated circuit, two or more integrated circuits, or may be a component of a multi-chip module (e.g., in which individual microprocessor dies are included in a single integrated circuit package and hence share a single socket).

Mobile device 102 may be equipped with one or more high-performance GPUs 114 providing high performance with regard to computations and graphics rendering. To process the graphics rendering instructions, CPU 112 may issue one or more graphics rendering commands to GPU 114 to cause GPU 114 to perform some or all of the rendering of the graphics data. GPU 114 may, in some instances, be built with a highly-parallel structure that provides more efficient processing of vector operations than CPU 112. Mobile device 102 may use GPU 114 to accelerate the rendering of graphics data for display. In some examples, browser application 120 executes on CPU 112 and/or GPU 114.

GPU 114 may, in some instances, be integrated into a motherboard of mobile device 102. In other instances, GPU 114 may be present on a graphics card that is installed in a port in the motherboard of mobile device 102 or may be otherwise incorporated within a peripheral device configured to interoperate with mobile device 102. In further instances, GPU 114 may be located on the same microchip as CPU 112 forming a system on a chip (SoC). GPU 114 may include one or more processors, such as one or more microprocessors, application specific integrated circuits (ASICs), field programmable gate arrays (FPGAs), digital signal processors (DSPs), or other integrated or discrete logic circuitry.

Display 118 may be integrated within mobile device 102. For example, display 118 may be a screen of mobile device 102. Alternatively, display 118 may be a stand-alone device coupled to mobile device 102 via a wired or wireless communications link. For example, display 118 may be a computer monitor or flat panel display coupled to mobile device 102 via a cable or wireless link.

In FIG. 1, user 103 may use browser application 120 to access data over network 104 from web server 130 and/or web server 132. Network interface card 119 may receive data from and send data to web servers 130 and 132 over network 104. Web server 130 hosts a website 105, and web server 132 hosts a website 107. A website is a set of related webpages typically served from a single Web domain. Browser application 120 may be hosted on mobile device 102 and used for retrieving, presenting, and traversing information resources provided by servers (e.g., web servers on the World Wide Web). An information resource is identified by a uniform resource identifier (URI) and may be a webpage, image, video, client-side scripts, and/or other piece of content.

Battery 116 powers mobile device 102. The use of browser application 120 may have an effect on battery 116's battery life. Battery life is the amount of time mobile device 102 runs before the battery needs to be recharged. It may be desirable to maximize the battery life of battery 116. Battery 116 may be, for example, a lithium-ion battery.

Some websites may be heavy, while others may be light on power consumption. Mobile device 102 includes a mobile database 106 that stores identifiers of one or more websites that have been identified as high power consuming websites. In some examples, mobile database 106 stores identifiers of one or more webpages belonging to websites identified as high power consuming websites. In some examples, mobile database 106 stores identifiers of individual websites that have been identified on a per-website basis as being high power consuming websites. The identifiers of the websites stored in mobile database 106 may have been based on mobile device 102's accesses to particular websites on a per-website basis. The identification of high power consuming websites loaded on a computing device on a per-website basis is described in U.S. patent application Ser. No. ______ to Arulesan et al., filed ______, entitled “Estimation of Power Consumption of Individual Websites,” which is incorporated herein by reference in its entirely.

It may be desirable to reduce the power consumed within browser application 120 in relation to rendering one or more webpages by performing certain actions (or not performing certain actions) before rendering the webpages identified in mobile database 106. A webpage is identified in mobile database 106 if the website including the webpage is listed in mobile database 106. The website is listed in mobile database 106 if an identifier of the website (e.g., URL of website) is listed in the mobile database. Mobile database 106 includes an identifier 140 that identifies website 105. In some examples, identifier 140 is a URL of website 105. In some examples, identifier 140 is a URL of webpage 136.

User 103 may point browser application 120 at website 105 by, for example, typing a URL of website 105 into an address bar of browser application 120. In some examples, mobile device 102 may send an HTTP request 134 for a webpage 136 of website 105. In response to HTTP request 134, web server 130 may send webpage 136 to mobile device 102. Browser application 120 may receive webpage 136 from web server 130.

### III. Example Methods

Mobile device 102 includes a browser application 120 including a power conservation module 122 and a rendering engine 123. Although in FIG. 1, power conservation module 122 is illustrated as being incorporated within browser application 120, this is not intended to be limiting and power conservation module 122 may be separate from browser application 120. Rendering engine 123 performs operations to render a webpage to display 118. Before rendering engine 123 renders webpage 136 to display 118, power conservation module 122 may perform one or more actions that conserves power within browser application 120. In some examples, the action that conserves power within browser application 120 causes rendering engine 123 to provide the user with less content than that included in the webpage 136 sent from web server 130. In some examples, the action that conserves power within browser application 120 causes rendering engine 123 to perform fewer operations for rendering webpage 136.

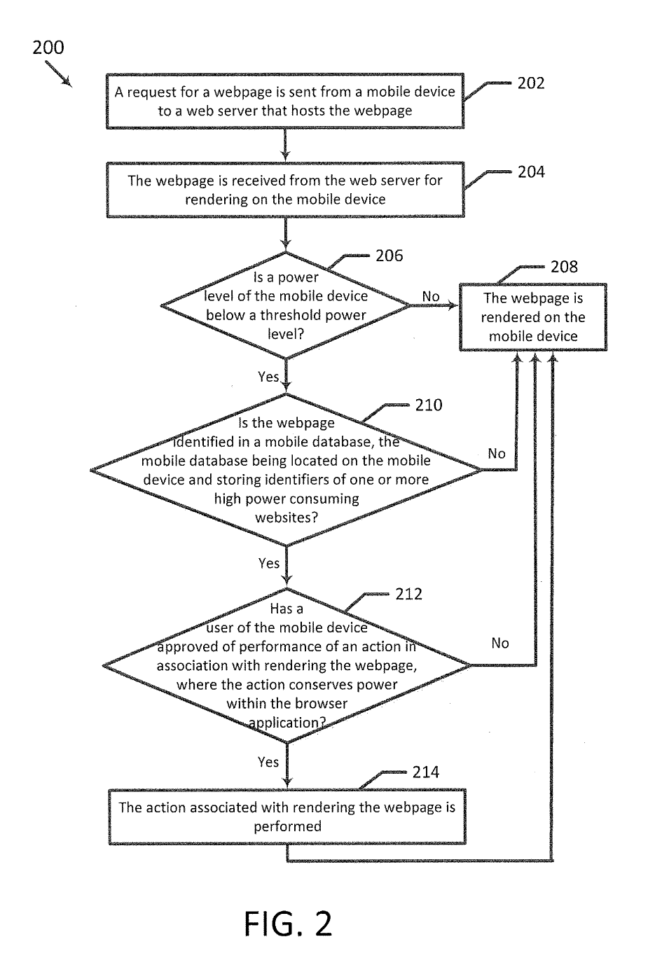

If the power level of battery 116 is below a threshold power level and user 103 attempts to access a website listed in mobile database 106 or to access a webpage identified in mobile database 106, power conservation module 122 may request approval from user 103 to allow browser application 120 to perform one or more actions to conserve power within the browser application, where performance of the action may be at the expense of website performance. FIG. 2 is a simplified flowchart illustrating a method 200 of conserving power within the browser application in accordance with one or more embodiments. Method 200 is not meant to be limiting and may be used in other applications. Method 200 includes blocks 202, 204, 206, 208, 210, 212, and 214.

In a block 202, a request for a webpage is sent from a mobile device to a web server that hosts the webpage. In an example, browser application 120 sends HTTP request 134 to web server 130, which hosts website 105 including webpage 136. Web server 130 may receive HTTP request 134, which may be a request for webpage 136. In response to HTTP request 134, web server 130 may send webpage 136 to mobile device 102. In a block 204, the webpage is received from the web server for rendering on the mobile device. In an example, mobile device 102 receives webpage 136 from web server 130 for rendering to display 118.

In a block 206, it is determined whether a power level of the mobile device is below a threshold power level. In an example, power conservation module 122 determines whether a power level of battery 116, which powers mobile device 102, is below a threshold power level. It should be understood that mobile device 102 may include one or more batteries, and power conservation module 122 may determine whether the combined power of each of the batteries powering the mobile device is below the threshold power level.

In a block 208, in response to a determination that the power level of the mobile device is not below the threshold power level, the webpage is rendered on the mobile device. In an example, in response to a determination that the power level of battery 116 is not below the threshold power level, rendering engine 123 renders webpage 136 to display 118. If the power level of mobile device 102 is not below the threshold power level, then mobile device 102 is not running low on battery power and it may be unnecessary for power conservation module 122 to tradeoff website performance for power consumption. Accordingly, rendering engine 123 may render the webpage as rendering engine 123 normally would.

In a block 210, it is determined whether the webpage is identified in a mobile database, the mobile database being located on the mobile device and storing identifiers of one or more high power consuming websites. In an example, power conservation module 122 determines whether webpage 136 is identified in mobile database 106, where mobile database 106 is located on mobile device 102 and stores identifiers (e.g., URLs) of one or more high power consuming websites. Power conservation module 122 may determine that a webpage is identified in mobile database 106 if it stores identifiers (e.g., URL) of websites that include the webpage. Power conservation module 122 may parse webpage 136 to identify the URL of the webpage or URL of the website that includes the webpage.

In response to a determination that the webpage is not identified in the mobile database, process flow proceeds from block 210 to block 208, in which the webpage is rendered on the mobile device. In an example, in response to a determination that webpage 136 is not identified in mobile database 106, rendering engine 123 renders webpage 136 to display 118 (as it normally would). If a webpage is not identified in mobile database 106, then rendering the webpage may not consume much power and it may be unnecessary for power conservation module 122 to perform one or more actions that reduces power consumption within browser application 120, where the one or more actions may gracefully degrade the website's performance. Although performance of the action may reduce power consumption within browser application 120, it may be more desirable to provide the user with a better user experience by providing the full performance of the website because battery power is not an issue.

In contrast, if a webpage is identified in mobile database 106, then the webpage is part of a website that has been identified as being a high power consuming website. Accordingly, it may be desirable for power conservation module 122 to optimize the rendering of the webpage such that less power is consumed within browser application 120 in association with rendering the webpage. In response to a determination that the webpage is identified in the mobile database, process flow proceeds from block 210 to a block 212, in which approval is requested from a user to perform an action in association with rendering the webpage, where the action conserves power within the browser application. The action may conserve power in association with rendering the webpage, but at the expense of the website's performance. In an example, in response to a determination that webpage 136 is identified in mobile database 106, power conservation module 122 requests approval from user 103 to allow browser application 120 to perform an action in association with rendering webpage 136, where the action conserves power within browser application 120 but may do so at the expense of website 105's performance.

To provide the user with more information, power conservation module 122 may provide a warning to the user that mobile device 102 is running low on battery power and ask whether the user would like browser application 120 to perform an action that conserves power within the browser application for rendering the webpage, but also inform the user that the action may affect the website's performance. With this warning, the user may have a better understanding of the website's performance and acknowledge that certain actions are being performed by browser application 120 in order to prolong battery life, while still providing the user with content of the webpage. In some examples, power conservation module 122 may provide a prompt asking the user whether she would like to tradeoff power consumption for website performance. The user may either choose to do so or to reject the tradeoff. In this way, the user may be aware that mobile device 102 is reducing the power consumption in association with the user's browsing of the Web, but at the cost of the user's browsing experience.

In response to a determination that the user has not approved of performance of the action in association with rendering the webpage, where the action conserves power within the browser application, process flow proceeds from block 212 to 208, in which the webpage is rendered. The action may cause the website's performance to be degraded, and thus the user may decide to not approve of browser application 120 performing the action. If power conservation module 122 does not perform the action that conserves power within browser application 120, then battery 116 may run out of battery power faster than if power conservation module 122 did perform the action. In an example, in response to a determination that user 103 has not approved of browser application 120 performing an action that conserves power within browser application 120, rendering engine 123 renders webpage 136 (as it normally would).

In response to a determination that the user has approved of performance of the action in association with rendering the webpage, where the action conserves power within the browser application, process flow proceeds from block 212 to 214, in which the action associated with rendering the webpage is performed. In an example, in response to a determination that user 103 has approved of performance of the action in association with rendering webpage 136, where the action conserves power within browser application 120, the power conservation module 122 performs the action associated with rendering the webpage. In this example, the action may conserve power within browser application 120, but provide the user with fewer features of the website.

In some embodiments, blocks 202, 204, 206, 208, 210, 212, and/or 214 may be performed for any rendering of a webpage by mobile device 102. It is also understood that additional processes may be performed before, during, or after blocks 202, 204, 206, 208, 210, 212, and/or 214 discussed above. It is also understood that one or more of the blocks of method 200 described herein may be omitted, combined, or performed in a different sequence as desired.

In an example, block 206 may be omitted and process flow may proceed from block 204 to 210. In this example, power conservation module 122 may determine whether a webpage for rendering to display 118 is identified in mobile database 106 regardless of mobile device 102's battery power level.

In another example, block 212 may be omitted. In this example, power conservation module 122 may perform the action without the user's knowledge. Additionally, it may be annoying for the user to browse a website and be requested for approval of the action that conserves power within browser application 120 for each requested webpage of the loaded website. In an example, if user 103 has already approved of browser application 120 performing one or more actions that conserves power within the browser application in association with the rendering of a particular webpage, then it may be assumed that the user approves of the one or more actions being performed on all webpages of the same website that includes the particular webpage. For example, if user 103 has already approved of browser application 120 performing an action that conserves power within the browser application in association with the rendering of webpage 136, then power conservation module 122 may assume that user 103 has approved of the one or more actions being performed on all webpages of website 105.

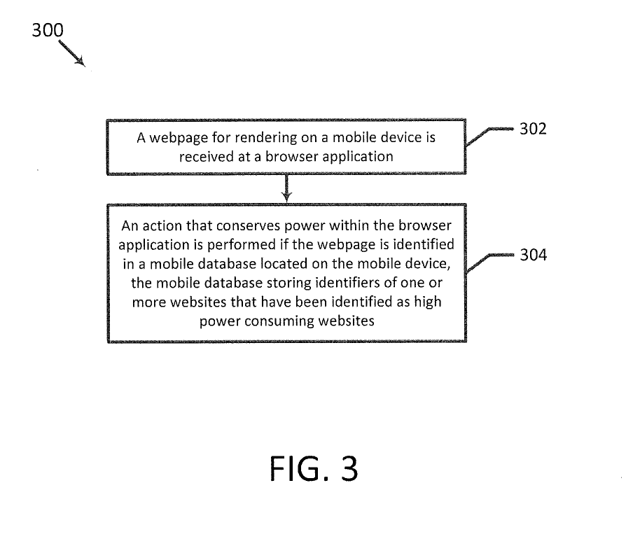

FIG. 3 is a simplified flowchart illustrating a method 300 of conserving power within the browser application in accordance with one or more embodiments. Method 300 is not meant to be limiting and may be used in other applications. Method 300 includes blocks 302 and 304.

In a block 302, a webpage for rendering on a mobile device is received at a browser application. In an example, browser application 120 receives webpage 136 for rendering on mobile device 102. In a block 304, an action that conserves power within the browser application is performed if the webpage is identified in a mobile database located on the mobile device, the mobile database storing identifiers of one or more websites that have been identified as high power consuming websites. In an example, power conservation module 122 performs an action that conserves power within browser application 120 if webpage 136 is identified in mobile database 106 located on mobile device 102, mobile database 106 storing identifiers of one or more websites that have been identified as high power consuming websites.

In some embodiments, blocks 302 and 304 may be performed for any rendering of a webpage by mobile device 102. It is also understood that additional processes may be performed before, during, or after blocks 302 and 304 discussed above. It is also understood that one or more of the blocks of method 300 described herein may be omitted, combined, or performed in a different sequence as desired.

IV. Example Actions that Conserve Power within the Browser Application

As discussed, power conservation module 122 may perform an action that conserves power within the browser application in relation to loading a website at the expense of the website's performance. In the below examples, particular features that most affect power consumption and other throttling settings may be determined by using expert analysis or applying learning techniques. The expert analysis may include predefined information stored on mobile device 102. Expert analysis may indicate that, for example, a particular element included in a webpage is a high power consuming element compared to other elements in the webpage. In some examples, the expert analysis is hard coded into the logic. The learning techniques may be applied to the expert analysis (e.g., predefined information) such that the determination of which action(s) to perform and how they are performed are refined and dynamically determined.

In some examples, mobile device 102 may adjust the performance of the hardware components in mobile device 102 and/or adjust the workload performed by browser application 120 to conserve power within the browser application at the expense of website performance. Mobile device 102 may perform one or more of the below actions that conserves power in mobile device 102 in relation to rendering a webpage if, for example, the webpage is identified in mobile database 106. Additionally, the user may set up her preferences to perform one or more of the below actions if the battery power of mobile device 102 falls below a threshold power level. In another example, the user may set up her preferences to perform one or more of the below actions regardless of whether the battery power of mobile device 102 falls below the threshold power level.

### A. Adjust Performance of Hardware Components

In some examples, performance of an action that conserves power in mobile device 102 in association with rendering a webpage may include throttling a CPU frequency of CPU 112. In such an example, mobile device 102 may reduce the frequency of CPU 112. CPU frequency may refer to the rate at which the system clock (not shown) is toggling. The higher the CPU frequency of CPU 112, the more work CPU 112 may be performing, which may lead to a higher power consumption. Similarly, the lower the CPU frequency of CPU 112, the less work CPU 112 may be performing, which may lead to a lower power consumption. Accordingly, by reducing the frequency of CPU 112, browser application 120 may consume less power when rendering the webpage.

In some examples, performance of the action that conserves power in mobile device 102 in association with rendering a webpage may include modifying the number and/or type of processing core used for rendering the webpage. In such an example, CPU 112 may be a multi-core processor, and mobile device 102 may reduce the number of processing cores of CPU 112 used to render the webpage. The more processing cores used to render a webpage, the more work the CPU may be performing, which may lead to higher power consumption. Similarly, the fewer processing cores used to render a webpage, the less work the CPU may be performing, which may lead to lower power consumption. Accordingly, by reducing the number of processing cores of CPU 112 used to render a webpage, browser application 120 may consume less power. Additionally, mobile device 102 may modify the type of processing core of CPU 112 used to render the webpage. Some processing cores may, by design, consume less power than others. Accordingly, using one or more of these processing cores to render a webpage may lead to lower power consumption.

### B. Adjust the Workload in Relation to the Browser Application

Rather than or in addition to adjusting the performance of hardware components in mobile device 102, it may be desirable to adjust the workload performed by browser application 120 in relation to rendering webpages or to adjust the workload that is emitted from browser application 120 to the hardware components. Browser application 120 may load webpage 136 and parse the webpage to identify various elements within the webpage.

In some examples, performance of the action that conserves power within the browser application in association with rendering a webpage may include removing one or more high power consuming elements from the webpage. In an example, one or more high power consuming elements included in the webpage may be a request animation frame (rAF) element. A rAF element informs browser application 120 that a particular element included in webpage 136 will be animated and the animation should happen at the maximum compositing frame rate that browser application 120 can achieve on the particular platform of mobile device 102. The maximum compositing frame rate may be the maximum refresh rate that the underlying platform can support. An example of the maximum compositing frame rate for mobile device 102 is 60 frames per second (fps). In this example, rAF elements animate at 60 fps on display 118 of mobile device 102. The frame rate is driven by the underlying hardware. Accordingly, other mobile devices may have different maximum compositing frame rates. In some examples, a mobile device may have a maximum compositing frame rate of 50 fps or 70 fps. In another example, one or more high power consuming elements included in the webpage may be a video element or other animated element (e.g., Graphics Interface Format (GIF) element that may cause frequent updates to the webpage). The high power consuming elements included in the webpage may typically enhance the user's experience, but may not be the content that the user cares about viewing. Accordingly, it may be desirable for power conservation module 122 to remove one or more of these high power consuming elements from webpage 136 before rendering engine 123 renders the webpage, thus conserving power within browser application 120. Rendering engine 123 may render webpage 136 after the high power consuming elements have been removed from the webpage.

A webpage may contain one or more elements, and a number of these elements may change over time. While browser application 120 is loading a webpage, browser application 120 may show portions of the webpage to user 103 as it is being downloaded. Browser application 120 may be programmed to render intermediate frames to enhance the user's experience and let the user know that browser application 120 has not frozen and is still in the process of loading the webpage. The rendering of the intermediate frames may have a negative impact on battery life. As browser application 120 continues to download the remaining portions of the webpage, the content that has already been downloaded and made ready for rendering may change. Accordingly, during a first life cycle of this webpage load, a large number of main frame commits may have occurred because the elements contained in or referenced by the webpage may be undergoing changes as more content of the webpage is downloaded. It may be desirable to avoid rendering at least one of the intermediate frames because the final frame of the displayed webpage may be different from the intermediate frames, thus saving processing power that would have been consumed for rendering the intermediate frame.

In some examples, performance of the action that conserves power within the browser application in association with rendering a webpage may include reducing a number of main frame commits associated with the rendering of the webpage. The number of main frame commits may correspond with the rendering of webpages of website 105 at mobile device 102. Browser application 120 may have a main thread that handles the layout of webpages (e.g., placement of elements contained in or referenced by a webpage) and a rendering thread that receives a workload from the main thread to process and render to display 118. The actual processing of a webpage occurs in the main thread. The rendering thread may also be referred to as the compositing thread. Changes are collected in the main thread and transferred to the rendering thread (referred to as a main frame commit). The layout portion of rendering a webpage may be referred to as a main frame commit. In response to a determination that a threshold number of elements contained in or referenced by a webpage have been downloaded and have changed since the last commit, browser application 120 may commit the content to the rendering thread for display on display 118.

As discussed, the content that is shown to user 103 may or may not be the final webpage, and may be referred to as an intermediate frame if the content displayed is not the final webpage. Accordingly, it may be desirable for power conservation module 122 to instruct rendering engine 123 to reduce a number of main frame commits associated with the rendering of the webpage before rendering engine 123 renders the webpage, thus conserving power within browser application 120. Accordingly, rendering engine 123 may reduce the number of main frame commits associated with the rendering of the webpage. In an example, browser application 120 may wait for a threshold amount of time to elapse before issuing another main frame commit. In this example, browser application 120 may “collect” the changes of multiple elements that are changing dynamically over time together and issue a main frame commit. As such, rather than viewing consecutive frames N, N+1, N+2, N+3, and then frame N+4 on display 118, the user may view frame N and then frame N+4 consecutively, without viewing frames N+1, N+2, or N+3 regardless of the element changes in between.

In some examples, performance of the action that conserves power within the browser application in association with rendering a webpage may include reducing a number of compositing cycles associated with the rendering of the webpage. Browser application 120 may decide to trigger a compositing cycle in response to the determination to commit the content to the rendering thread, but may also decide not to trigger a compositing cycle in response to the determination to commit the content to the rendering thread. The more compositing cycles that are triggered, the higher the likelihood of GPU 114 being used for rendering operations. Accordingly, it may be desirable for power conservation module 122 to instruct rendering engine 123 to reduce a number of compositing cycles associated with the rendering of the webpage before rendering engine 123 renders the webpage, thus conserving power within browser application 120. Accordingly, rendering engine 123 may reduce the number of compositing cycles associated with the rendering of the webpage. In an example, browser application 120 may wait for a threshold amount of time to elapse before triggering a compositing cycle. In this example, GPU 114 may “collect” the changes of multiple elements that are changing dynamically over time and trigger a compositing cycle. As such, rather than viewing consecutive frames N, N+1, N+2, N+3, and then frame N+4 on display 118, the user may view frame N and then frame N+4 consecutively, without viewing frames N+1, N+2, or N+3 regardless of the element changes in between.

In some examples, performance of the action that conserves power within the browser application in association with rendering a webpage may include delaying a timing event (e.g., set by a JavaScript timer) that triggers execution of a client-side script included in the webpage. In an example, the client-side script includes JavaScript code, and the webpage is coded with an instruction that one or more particular operations should be performed periodically (e.g., computations computed every 10 milliseconds). While it may be ideal for browser application 120 to execute the client-side script in accordance with the webpage's instructions, a high power consuming website may impose a drain on CPU 112 and battery 116. Accordingly, to conserve power within browser application 120, it may be desirable for power conservation module 122 to instruct rendering engine 123 to artificially delay performance of the operation beyond the instructed time. In another example, power conservation module 122 may instruct the JavaScript timer to reset every 20 milliseconds (rather than every 10 milliseconds) to trigger the timing event that triggers execution of the client-side script included in the webpage. In this example, rendering engine 123 may execute the client-side script included in the webpage every 20 milliseconds rather than every 10 milliseconds.

In some examples, webpage 136 may include one or more animation elements. In some examples, performance of the action that conserves power within the browser application in association with rendering a webpage may include delaying a repaint of a browser window for a subsequent animation frame including the animation element. In an example, power conservation module 122 instructs rendering engine 123 to delay a repaint of a browser window for a subsequent animation frame including the animation element. Accordingly, rendering engine 123 may delay a repaint of a browser window for a subsequent animation frame including the animation element.

Mobile device 102 may consume power to produce light for display 118. In some examples, performance of the action that conserves power within the browser application in association with rendering a webpage may include using a different color scheme on display 118. The display technology (e.g., liquid-crystal display (LCD)) may determine whether a white pixel or a darker pixel consumes more power to display. In an example, browser application 120 may use a darker color scheme compared to mobile device 102's default color scheme and darken the user interface (UI) to save power. In this example, browser application 120 may consume more power in rendering a white pixel to display 118 compared to a darker pixel because of the energy required to emit light for the white pixel. Accordingly, in an example, browser application 120 may darken one or more pixels on display 118 to conserve power.

In another example, browser application 120 may use a lighter color scheme compared to mobile device 102's default color scheme and lighten the UI to save power. In this example, browser application 120 may consume more power in rendering a black (or dark) pixel to display 118 compared to a white pixel because display 118 may emit light energy from a backlight that shines through the matrix of pixels to which the output is rendered (e.g., display 118). If a pixel displayed on display 118 is black, the mobile device 102's backlight still outputs the full light as normal, but rendering engine 123 also blocks all of that light to create the appearance of a black pixel. Accordingly, in an example, browser application 120 may lighten one or more pixels on display 118 to conserve power.

Additionally, browser application 120 may generate multiple resolutions of tiles. In an example, browser application 120 may generate tiles of a webpage having different resolutions. A low quality (LQ) tile is a lower resolution version of a corresponding high quality (HQ) tile. While HQ tiles are tiles that may have the same resolution as the screen, LQ tiles are scaled down versions of the information content overlapped by the LQ tiles, LQ tiles are relatively faster to render compared to fully rendered tiles, referred to as HQ tiles, and may be used for quickly conveying a thumbnail sketch of the webpage content overlapped by the LQ tiles. Browser application 120 may generate LQ tiles as a backup for HQ tiles if there is insufficient time to render the HQ tiles. In this example, browser application 120 may render the LQ tiles before rendering their corresponding HQ tiles. Modern CPUs are typically capable of rendering HQ tiles. In situations in which CPU 112 is able to render the HQ tiles of a webpage, generating LQ tiles may be a waste of time and unnecessarily consume processing cycles. In some examples, performance of the action that conserves power within the browser application in association with rendering a webpage may include determining whether HQ tiles have been generated for the webpage. In response to a determination that HQ tiles have been generated for the webpage, power conservation module 122 may block the generation of LQ tiles for the webpage. For example, power conservation module 122 may instruct browser application 120 to not generate LQ tiles for the webpage. Accordingly, rendering engine 123 may determine to not generate LQ tiles for the webpage.

Browser application 120 may generate filler tiles. A filler tile is a lower resolution version of a corresponding LQ tile. Filler tiles may hardly be readable to the human eye, but may be helpful for browser application 120 to render so that display 118 is not blank. In some examples, performance of the action that conserves power within the browser application in association with rendering a webpage may include determining whether HQ and LQ tiles have been generated for the webpage. In response to a determination that HQ and LQ tiles have been generated for the webpage, power conservation module 122 may block the generation of LQ tiles for the webpage. For example, power conservation module 122 may instruct browser application 120 to not generate filler tiles for the webpage. Accordingly, rendering engine 123 may determine to not generate filler tiles for the webpage.

Pre-rendering content of a webpage may refer to speculatively rendering content of the webpage that is off-screen (e.g., not visible on display 118). Browser application 120 may pre-render content in relation to the rendering of a webpage. For example, browser application 120 may pre-render the content that would be displayed if the user were to scroll up, down, left, and/or right on the webpage. Browser application 120 may pre-render that content by fetching it before the user actually scrolls the webpage. Browser application 120 may store the pre-rendered content in browser application 120's cache. In this way, if the user scrolls the webpage, browser application 120 may fetch the appropriate pre-rendered content from its cache and render the cached content quickly for the user to view. If the user does not scroll the webpage, however, the actions involved in pre-rendering the content consumed unnecessary processing cycles and had an unnecessary negative impact on power. Modern devices may be powerful enough to render content on the fly. As such, in some examples, performance of the action that conserves power within the browser application in association with rendering a webpage may include reducing the amount of content that is pre-rendered. In an example, power conservation module 122 may instruct rendering engine 123 to not pre-render any content if battery 116 is below a threshold power level. As such, rendering engine 123 may determine to not pre-render content or only pre-render content up to a particular amount of bytes.

In some examples, performance of the action that conserves power within the browser application in association with rendering a webpage may include turning off the scrollbar animations or UI effects in the webpage. In an example, power conservation module 122 may remove the scrollbar animations and/or UI effects from the webpage. Rendering engine 123 may render the webpage after the scrollbar animations and/or UI effects have been removed from the webpage.

As discussed above and further emphasized here, FIGS. 1 and 2 are merely examples, which should not unduly limit the scope of the claims. Although mobile device 102 is illustrated as being a mobile device, other embodiments including devices that are not mobile are within the scope of the present disclosure. For device 102 may be a stationary computing device such as a desktop computer.

### VI. Example Computing System

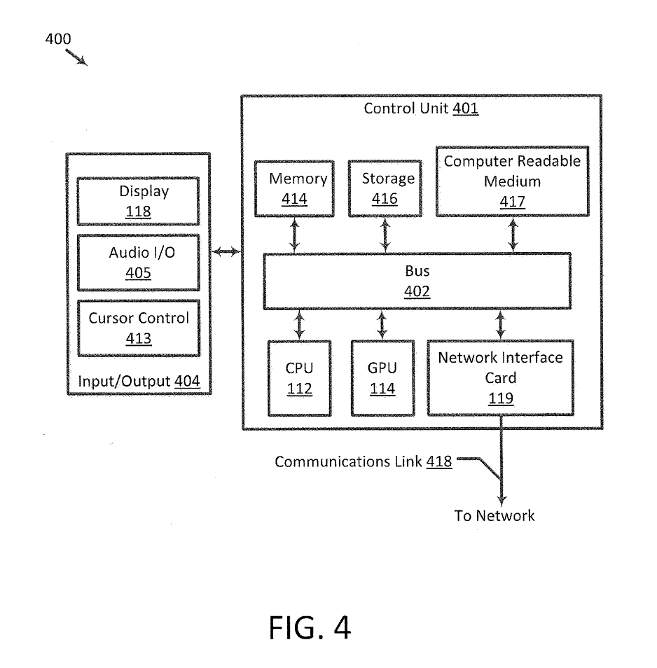

FIG. 4 is a block diagram of an example computer system 400 suitable for implementing any of the embodiments disclosed herein. In various implementations, computer system 400 may be mobile device 102. Computer system 400 may include one or more processors. Computer system 400 may additionally include one or more storage devices each selected from a group including hard disk, RAM, PROM, EPROM, FLASH-EPROM, any other memory chip or cartridge, and/or any other medium from which a processor or computer is adapted to read. The one or more storage devices may include stored information that may be made available to one or more computing devices and/or computer programs (e.g., clients) coupled to computer system 400 using a computer network (not shown). The computer network may be any type of network including a LAN, a WAN, an intranet, the Internet, a cloud, and/or any combination of networks thereof that is capable of interconnecting computing devices and/or computer programs in the system.

Computer system 400 includes a bus 402 or other communication mechanism for communicating information data, signals, and information between various components of computer system 400. Components include an input/output (I/O) component 404 for processing user actions, such as selecting keys from a keypad/keyboard or selecting one or more buttons or links, etc., and sends a corresponding signal to bus 402. I/O component 404 may also include an output component such as a display 118, and an input control such as a cursor control 413 (such as a keyboard, keypad, mouse, etc.). User 103 may use cursor control 413 to point browser application 120 to a website and retrieve webpages that are displayed on display 118.

An audio I/O component 405 may also be included to allow a user to use voice for inputting information by converting audio signals into information signals. Audio I/O component 405 may allow the user to hear audio. A transceiver or network interface 406 transmits and receives signals between computer system 400 and other devices via a communications link 418 to a network. In an embodiment, the transmission is wireless, although other transmission mediums and methods may also be suitable. CPU 112, which may be a micro-controller, digital signal processor (DSP), or other processing component, processes these various signals, such as for display on display 118 of computer system 400 or transmission to other devices via communications link 418. Browser application 120 may execute on CPU 112. CPU 112 may also control transmission of information, such as cookies or IP addresses, to other devices.

Computer system 400 includes GPU 114. CPU 112 may send a stream of commands to GPU 114 via bus 402. Although bus 402 is illustrated as being the path that delivers data between CPU 112 and GPU 114, this is not intended to be limiting and other embodiments using a different mechanism to deliver data between CPU 112 and GPU 114 are within the scope of the disclosure,

Components of computer system 400 also include a system memory component 414 (e.g., RAM), a static storage component 416 (e.g., ROM), and/or a computer readable medium 417. Computer system 400 performs specific operations by CPU 112 and other components by executing one or more sequences of instructions contained in system memory component 414. Logic may be encoded in computer readable medium 417, which may refer to any medium that participates in providing instructions to CPU 112 for execution. Such a medium may take many forms, including but not limited to, non-volatile media, volatile media, and transmission media. In various implementations, non-volatile media include optical, or magnetic disks, or solid-state drives, volatile media include dynamic memory, such as system memory component 414, and transmission media include coaxial cables, copper wire, and fiber optics, including wires that include bus 402. In an embodiment, the logic is encoded in non-transitory computer readable medium. Computer readable medium 417 may be any apparatus that can contain, store, communicate, propagate, or transport instructions that are used by or in connection with CPU 112. Computer readable medium 417 may be an electronic, magnetic, optical, electromagnetic, infrared, or semiconductor device or a propagation medium, or any other memory chip or cartridge, or any other medium from which a computer is adapted to read. In an example, transmission media may take the form of acoustic or light waves, such as those generated during radio wave, optical, and infrared data communications.

In various embodiments of the present disclosure, execution of instruction sequences to practice the present disclosure may be performed by computer system 400. In various other embodiments of the present disclosure, a plurality of computer systems 400 coupled by communications link 418 to the network (e.g., such as a LAN, WLAN, PTSN, and/or various other wired or wireless networks, including telecommunications, mobile, and cellular phone networks) may perform instruction sequences (e.g., methods 200 or 300) to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the spirit of the present disclosure. In addition, where applicable, it is contemplated that software components may be implemented as hardware components, and vice-versa.

Application software in accordance with the present disclosure may be stored on one or more computer readable mediums. It is also contemplated that the application software identified herein may be implemented using one or more general purpose or specific purpose computers and/or computer systems, networked and/or otherwise. Where applicable, the ordering of various actions or blocks described herein may be changed, combined into composite actions or blocks, and/or separated into sub-actions or blocks to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Changes may be made in form and detail without departing from the scope of the present disclosure. Thus, the present disclosure is limited only by the claims.

What is claimed is:

1. A method of conserving power within a browser application, comprising:
receiving, at a browser application, a webpage for rendering on a mobile device; and
performing an action that conserves power within the browser application if the webpage is identified in a mobile database located on the mobile device, the mobile database storing identifiers of one or more websites that have been identified as high power consuming websites.

2. The method of claim 1, wherein performing the action includes reducing a number of compositing cycles associated with the rendering of the webpage.

3. The method of claim 1, wherein performing the action includes reducing a number of main frame commits associated with the rendering of the webpage.

4. The method of claim 1, wherein the webpage includes an animation element, and wherein performing the action includes delaying a repaint of a browser window for a subsequent animation frame including the animation element.

5. The method of claim 1, further comprising:
requesting approval from a user of the mobile device to tradeoff power consumption for performance if an identifier of the webpage is stored in the mobile database, and wherein performing the action includes performing the action in response to receiving approval from the user to tradeoff power consumption for performance.

6. The method of claim 1, wherein the webpage is identified in the mobile database if a uniform resource locator (URL) of a website including the webpage is stored in the mobile database.

7. The method of claim 1, wherein the webpage is of a website that has been identified as being a high power consuming website.

8. The method of claim 7, wherein performing the action includes removing one or more elements from the webpage.

9. The method of claim 7, wherein performing the action includes delaying a timing event that triggers execution of the client-side script.

10. The method of claim 1, further comprising:
rendering the webpage if the webpage is not identified in the mobile database.

11. The method of claim 1, further comprising:
rendering the webpage after the action is performed.

12. A system for conserving power within a browser application, comprising:
a rendering engine that receives a webpage for rendering on a mobile device; and
a power conservation module that performs an action that conserves power within the browser application if the webpage is identified in a mobile database located on the mobile device, wherein the mobile database stores identifiers of one or more websites that have been identified as high power consuming websites,
wherein the rendering engine renders the webpage after the power conservation module performs the action if the power conservation module performs the action.

13. The system of claim 12, wherein the power conservation module performs the action by reducing a number of compositing cycles associated with the rendering of the webpage.

14. The system of claim 12, wherein the power conservation module performs the action by reducing a number of main frame commits associated with the rendering of the webpage.

15. The system of claim 12, wherein the webpage includes an animation element, and wherein the power conservation module performs the action by delaying a repaint of a browser window for a subsequent animation frame including the animation element.

16. The system of claim 12, wherein the power conservation module requests approval from a user of the mobile device to tradeoff power consumption for performance if an identifier of the webpage is stored in the mobile database, and wherein the power conservation module performs the action in response to receiving approval from the user to tradeoff power consumption for performance.

17. The system of claim 12, wherein the webpage is identified in the mobile database if a uniform resource locator (URL) of a website including the webpage is stored in the mobile database.

18. The system of claim 12, wherein the webpage is of a website that has been identified as being a high power consuming website.

19. The system of claim 18, wherein the power conservation module performs the action by removing one or more elements from the webpage.

20. The system of claim 18, wherein the power conservation module performs the action by delaying a timing event that triggers execution of the client-side script.
